(19) United States
(12) Patent Application Publication
(10) Pub. No.: US 2012/0325795 A1
(43) Pub. Date: Dec. 27, 2012

(54) HEATING APPARATUS AND ANNEALING APPARATUS

(75) Inventors: Tomohiro SUZUKI, Nirasaki City (JP); Kazuhiro OOYA, Nirasaki City (JP); Masatake YONEDA, Nirasaki City (JP)

(73) Assignee: TOKYO ELECTRON LIMITED, Minato-ku (JP)

(21) Appl. No.: 13/606,936

(22) Filed: Sep. 7, 2012

Related U.S. Application Data
(63) Continuation of application No. PCT/JP2011/055260, filed on Mar. 7, 2011.

(30) Foreign Application Priority Data
Mar. 9, 2010 (JP) 2010-052421

(51) Int. Cl. H05B 3/00

(52) U.S. Cl. 219/209

(57) ABSTRACT

A heating apparatus includes a heat dissipating board formed of a metal; an insulating layer directly formed on the heat dissipating board; a plurality of wiring elements which are arranged on the insulating layer in a wiring pattern; and a plurality of LED elements provided on the wiring elements, respectively. The heating apparatus further includes metal wiring lines which electrically connect the adjacent LED elements to each other in series.

This application is a Continuation application of PCT International Application No. PCT/JP2011/055260 filed on Mar. 7, 2011, which designated the United States.

### FIELD OF THE INVENTION

The present invention relates to a heating apparatus having a light emitting diode (LED) element and an annealing apparatus including the heating apparatus.

### BACKGROUND OF THE INVENTION

Generally, in order to manufacture a semiconductor integrated circuit, various processes such as film formation, oxidation and diffusion, modification, etching, annealing and the like are performed repeatedly on a semiconductor wafer such as a silicon substrate or the like. Among these processes, in the annealing process for activating atoms of impurities doped into the wafer after ion implantation, the semiconductor wafer needs to be heated at a high speed in order to minimize diffusion of the impurities.

In a conventional annealing apparatus, the wafer is heated by using a halogen lamp. However, the halogen lamp requires at least about one second until it becomes stable as a heat source after being turned on. Therefore, there is recently suggested an annealing apparatus using as a heating source an LED element having fast switching responsiveness which is capable of rapidly increasing and decreasing a temperature compared to a halogen lamp (see, e.g., Japanese Patent Application Publication No. 2005-536045 (corresponding to International Patent Application Publication No. WO2004/015348)).

The heating apparatus used in the annealing apparatus is configured as shown in FIGS. 8A and 8B, for example. FIGS. 8A and 8B show a conventional heating apparatus having LED elements, wherein FIG. 8A is a cross sectional view and FIG. 8B is a plane view. The heating apparatus is installed so as to face a surface of a semiconductor wafer provided in a processing chamber (not shown) and heats the wafer W by rays (heat rays) emitted from the respective LED elements. The heating apparatus includes a heat dissipating board 2 formed of a metal plate made of, e.g. copper or the like.

In the example shown in FIGS. 8A and 8B, an insulating plate 6 is provided on a top surface of the heat dissipating board 2 via a joint layer 4 formed by soldering or the like, the insulating plate 6 being made of a ceramic such as nitride aluminum or the like. A plurality of rectangular wiring elements 8 is arranged in a predetermined wiring pattern on the surface of the insulating plate 6, and LED elements 10 are mounted on the respective wiring elements 8. The adjacent LED elements 10 are connected in series by metal wiring 11. In that case, the LED elements 10 are arranged at a high integration density in order to increase a light emitting amount per unit area.

In the conventional heating apparatus described above, the soldered joint layer 4 may be peeled off or the insulating plate 6 may be broken due to a difference of a linear expansion coefficient between the copper plate of the heat dissipating board 2 and the ceramic material or resin of the insulating plate 6. Further, when a high power is inputted in order to increase a light output of the LED elements 10, heat generation of the LED elements is increased. The increase in temperature of the LED elements 10 results in deterioration of a heat radiation efficiency.

If the LED elements are insufficiently cooled, the power inputted to the LED elements 10 is increased to compensate the deterioration of the heat radiation efficiency. However, this further increases the heat generation of the LED elements 10, in which leads to a saturated state in which the light output is not increased even though the power inputted to the LED elements 10 is increased. Thus, in order to increase the heat radiation efficiency of the LED elements 10, the heat generated from the LED elements 10 needs to be efficiently released. However, if air bubbles exist in the joint layer 4 formed by soldering, heat dissipation becomes non-uniform, which makes it difficult to release the heat efficiently.

### SUMMARY OF THE INVENTION

In view of the above, the present invention provides a heating apparatus and an annealing apparatus, capable of allowing elements to dissipate heat uniformly and efficiently.

In accordance with an aspect of the present invention, there is provided a heating apparatus including a heat dissipating board formed of a metal; an insulating layer directly formed on the heat dissipating board; a plurality of wiring elements which are arranged on the insulating layer in a wiring pattern; a plurality of LED elements provided on the wiring elements, respectively; and metal wiring lines which electrically connect the adjacent LED elements to each other in series.

In accordance with another aspect of the present invention, there is provided a heating apparatus including a heat dissipating board formed of a metal; an insulating layer formed on the heat dissipating substrate; a plurality of wiring elements which are arranged on the insulating layer in a wiring pattern; a plurality of LED elements provided on the wiring elements, respectively; and metal wiring lines which electrically connect the adjacent LED elements to each other in series, wherein a width “d” of a gap between the adjacent wiring elements is set to such a level as to satisfy a relational expression Vm/a<d, where “a” indicates a dielectric breakdown electric field of an insulating member provided between the wiring elements and “Vm” indicates a maximum potential difference between the wiring elements.

In accordance with still another aspect of the present invention, there is provided an annealing apparatus for annealing a target object to be processed. The annealing apparatus includes a processing chamber for accommodating the target object; a supporting unit for supporting the target object in the processing chamber; a gas supply unit for supplying a processing gas into the processing chamber; a gas exhaust unit for exhausting an atmosphere in the processing chamber; and the heating apparatus provided in the processing chamber.

In accordance with the invention, heat of LED elements can be uniformly and efficiently dissipated.

### BRIEF DESCRIPTION OF THE DRAWINGS

The objects and features of the present invention will become apparent from the following description of embodiments, given in conjunction with the accompanying drawings, in which:

FIG. 1 shows a cross sectional view showing a schematic configuration of an annealing apparatus including a heating apparatus in accordance with embodiments of the invention;

FIGS. 2A and 2B are plan views showing a surface of the heating apparatus;

FIGS. 3A and 3B are partially enlarged views showing LED elements of a heating apparatus in accordance with a first embodiment of the present invention;

FIG. 4 schematically shows an example of a connection state of a group of LED elements;

FIGS. 5A to 5F explain a manufacturing method of a heating apparatus;

FIGS. 6A and 6B are partially enlarged views showing LED elements of a heating apparatus in accordance with a second embodiment of the present invention;

FIG. 7 is a graph showing a relationship between a current and a light output in the heating apparatus in accordance with the second embodiment as compared with a conventional heating apparatus; and

FIGS. 8A and 8B show an example of a conventional heating apparatus having LED elements.

### DETAILED DESCRIPTION OF THE EMBODIMENTS

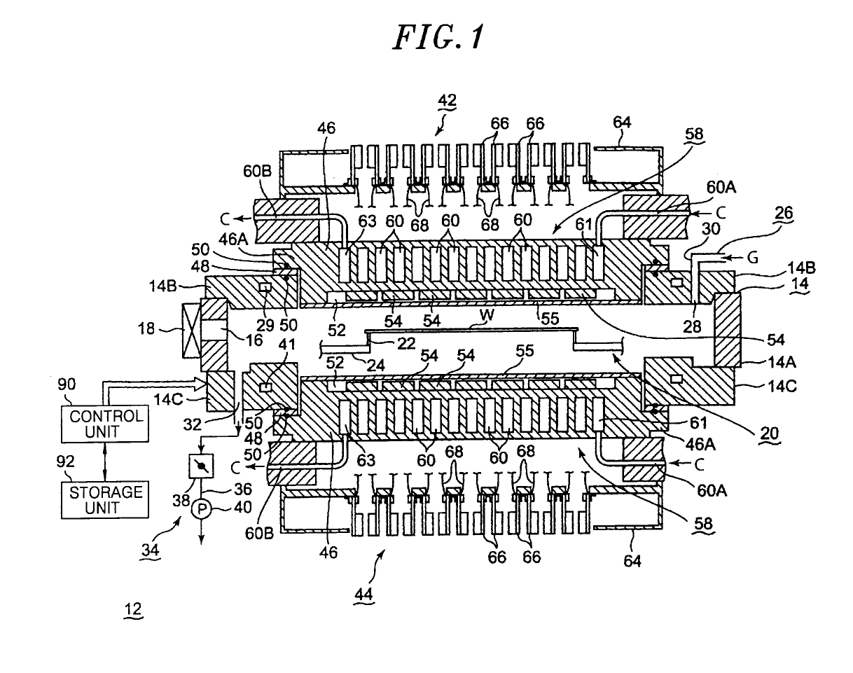

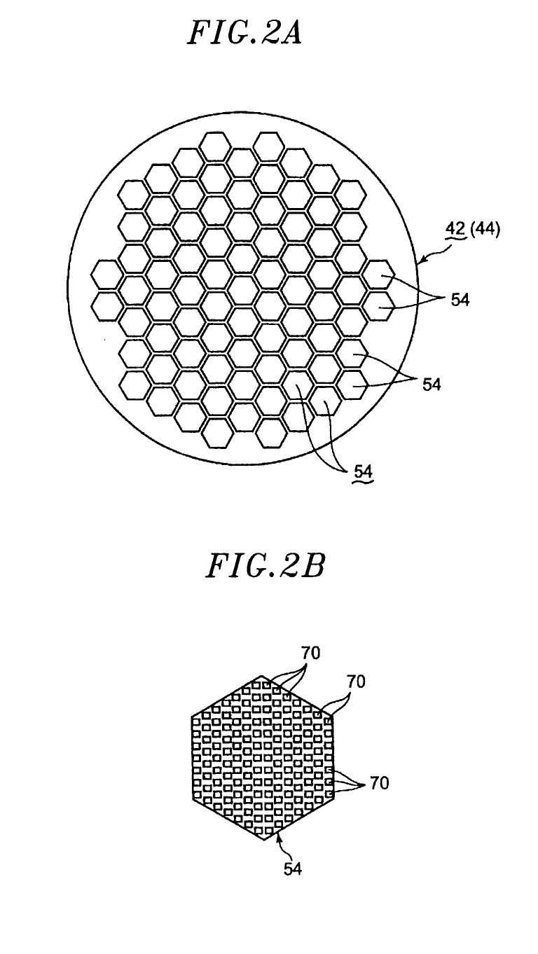

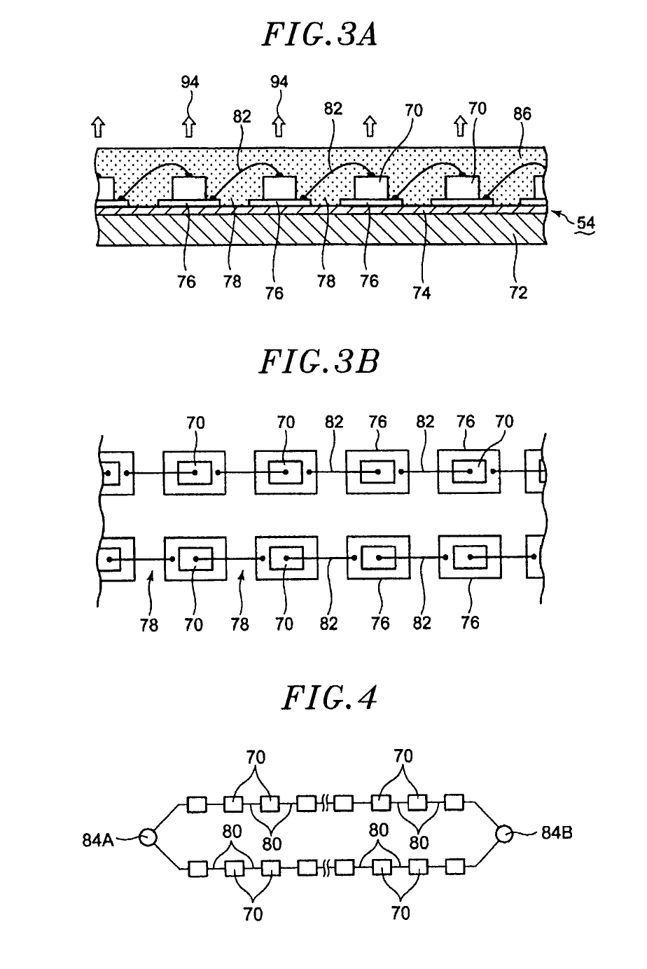

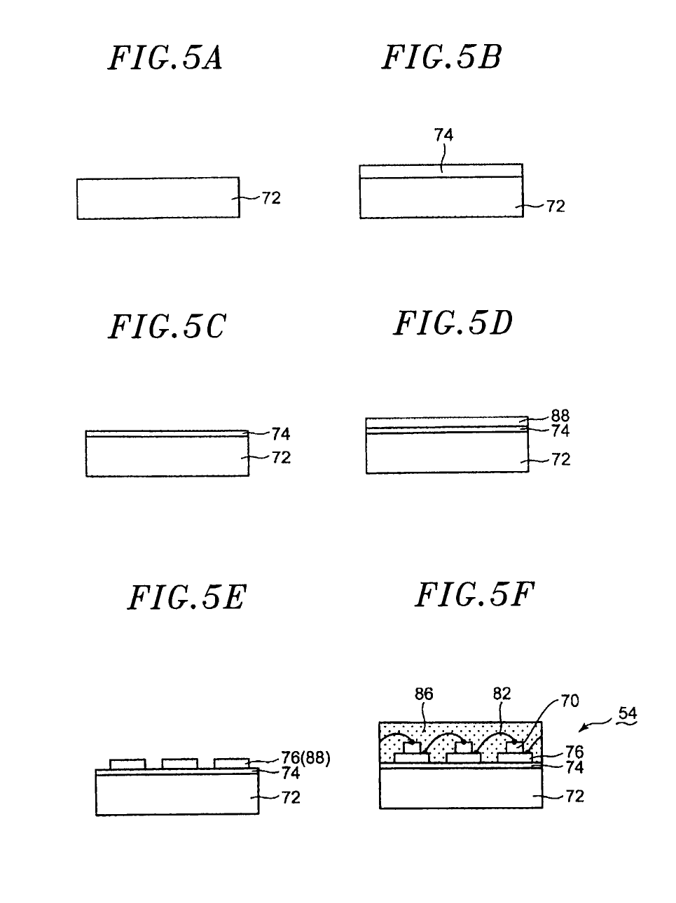

Hereinafter, a heating apparatus and an annealing apparatus in accordance with embodiments of the present invention will be described with reference to the accompanying drawings. FIG. 1 is a cross sectional view showing a schematic configuration of an annealing apparatus including a heating apparatus in accordance with embodiments of the present invention. FIGS. 2A and 2B are plan views showing a surface of the heating apparatus. FIGS. 3A and 3B are partially enlarged views showing LED elements of the heating apparatus in accordance with a first embodiment of the invention. FIG. 4 schematically shows an example of a connection state of a group of LED elements. FIGS. 5A and 5F explain a manufacturing method of the heating apparatus. Here, the case in which a semiconductor wafer formed of a silicon substrate is used as a target object to be processed and a wafer having a surface doped with impurities is annealed will be described as an example.

As shown in FIG. 1, the annealing apparatus 12 includes a hollow processing chamber 14 made of aluminum or aluminum alloy. The processing chamber 14 has a cylindrical sidewall 14A; a ceiling plate 14B coupled to an upper end of the sidewall 14A; and a bottom plate 14C coupled to a bottom portion of the sidewall 14A. Formed at the sidewall 14A is a loading/unloading port 16 for loading and unloading a semiconductor wafer W as a target object to be processed. An openable gate valve 18 is attached to the loading/unloading port 16.

Provided in the processing chamber 14 is a supporting unit 20 for supporting a wafer W. The supporting unit 20 has a plurality, e.g., three, supporting pins 22 (only two being shown in FIG. 1) and elevation arms 24 connected to lower ends of the supporting pins 22. Each of the elevation arms 24 is vertically moved by an actuator (not shown), so that the wafer W can be vertically moved while being supported by the upper ends of the supporting pins 22.

A gas supply unit 26 is disposed at a part of a peripheral portion of the ceiling plate 14B. The gas supply unit 26 has a gas inlet port 28 installed at the ceiling plate 14B and a gas line 30 connected to the gas inlet port 28. The gas supply unit 26 is configured to introduce a required processing gas into the processing chamber 14 at a flow rate controlled by a flow rate controller (not shown). Here, an inactive gas such as N₂ or the like, or a rare gas such as Ar, He or the like can be used as the processing gas. Further, an upper coolant path 29 through which a coolant for cooling the ceiling plate 14B flows is formed in the ceiling plate 14B.

A gas exhaust port 32 is disposed at a part of a peripheral portion of the bottom plate 14C. At the gas exhaust port 32, there is provided a gas exhaust unit 34 for exhausting an atmosphere in the processing chamber 14. The gas exhaust unit 34 has a gas exhaust line 36 connected to the gas exhaust port 32. A pressure control valve 38 and a gas exhaust pump 40 are sequentially installed on the gas exhaust line 36. A lower coolant path 41 through which a coolant for cooling the bottom plate 14C is formed in the bottom plate 14C.

A large diameter opening is formed at a center of the ceiling plate 14B, and a top surface-side heating apparatus 42 is installed at the opening to heat a top surface of the wafer W. Further, a large diameter opening is formed at a center of the bottom plate 14C, and a bottom surface-side heating apparatus 44 is installed at the opening to heat a bottom surface of the wafer W. Here, “the top surface of the wafer W” refers to a surface to be subjected to various processes such as film formation, etching and the like. If the bottom surface-side heating apparatus 44 has a sufficient heating capability, the top surface-side heating apparatus 42 can be omitted.

(Heating Apparatus)

Hereinafter, the heating apparatus will be illustrated. The top surface-side heating apparatus 42 and the bottom surface-side heating apparatus 44 have completely the same configuration except that they are vertically reversed. Here, the top surface-side heating apparatus 42 will be described. Like reference numerals will be given to like parts of the bottom surface-side heating apparatus 44, and the description thereof will be omitted.

The top surface-side heating apparatus 42 has an element attachment head 46 that is inserted into the opening of the ceiling plate 14B with a small gap therebetween. The element attachment head 46 is made of a highly conductive material, such as copper, aluminum, aluminum alloy or the like. The element attachment head 46 is supported by the ceiling plate 14B at a circular ring-shaped attachment flange 46A formed at an upper portion of the element attachment head 46 in a state where a thermal insulation member 48 is inserted between the attachment flange 46A and the ceiling plate 14B, the thermal insulation member 48 being made of polyetherimide or the like.

Sealing members 50 such as O-rings or the like are provided at an upper and a lower portion of the thermal insulation member 48 to maintain airtightness thereof. An element attachment recess 52 having a diameter slightly larger than that of the wafer W is formed at a bottom surface of the element attachment head 46, and a plurality of LED modules 54 is provided at such a region on a top surface (inner planar surface) of the element attachment recess 52 as to cover at least the entire surface of the wafer W. A light transmitting plate 55 formed of, e.g., a quartz plate, is attached to the opening of the element attachment recess 52. The LED modules 54 radiate lights (heat rays) toward the wafer W.

A cooling unit 58 is installed above the LED modules 54, i.e., at an opposite side to the wafer W. The cooling unit 58 includes a coolant path 60 having a rectangular cross section, the coolant paths being formed in the element attachment head 46. A coolant inlet 61 disposed at one end of the coolant path 60 is connected to a coolant introducing line 60A, and a coolant outlet 63 disposed at the other end of the coolant path 60 is connected to a coolant discharge line 60B. The coolant absorbs heat generated from the LED modules 54 while flowing in the coolant path 60, thereby cooling the LED modules 54. As for the coolant, Fluorinert, Galden (registered trademarks) or the like may be used. For example, the coolant path 60 may be formed in a zigzag shape substantially over the entire element attachment head 46.

A power supply control box 64 is installed at an opposite side to the LED modules 54. In the power supply control box 64, control boards 66 are provided in such a way as to correspond to the respective LED modules 54. Power supply lines 68 for supplying power to the LED modules 54 respectively extend from the control boards 66.

As shown in FIG. 2A, the LED modules 54 are formed in a regular hexagonal shape having one side of about 25 mm, for example, and arranged densely such that adjacent sides thereof are almost in contact with each other. Although a single LED module 54 or a plurality of LED modules 54 may be provided, about 80 LED modules 54 are provided in the case of a wafer W having a diameter of about 300 mm. FIG. 2B is an enlarged plan view showing each of the LED modules. One LED module 54 has a plurality of LED elements 70 arranged on a surface thereof in a vertical and a horizontal direction.

In that case, each of the LED elements 70 is formed in a rectangular shape of about 0.5 mm×0.5 mm, and about 1000 to 2000 LED elements 70 are mounted on each LED module 54. The LED elements 70 in one LED module 54 are divided into a plurality of groups, and the LED elements 70 in the same group are electrically connected in series. Hereinafter, the installation state of the LED elements will be described in detail. FIGS. 3A and 3B are partially enlarged views showing the LED element, wherein FIG. 3A is a cross sectional view and FIG. 3B is a plan view.

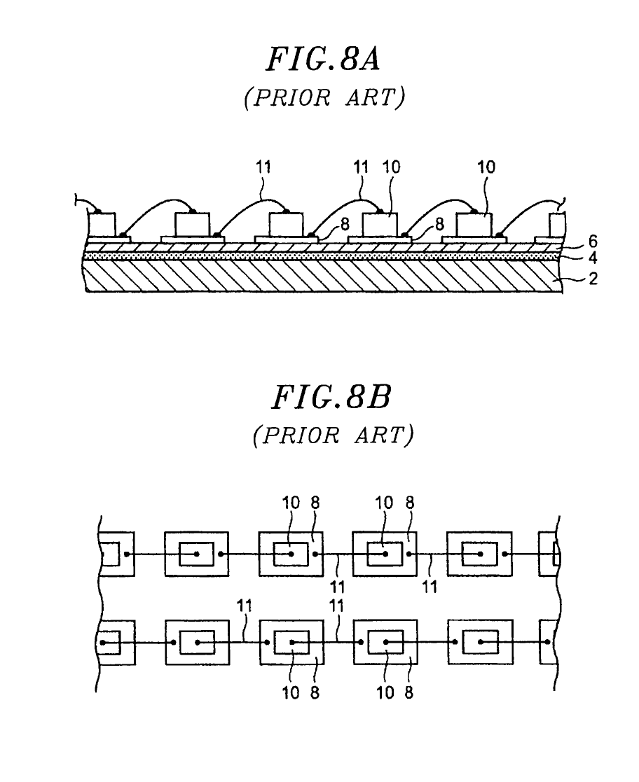

As shown in FIG. 3A, the LED module 54 has a heat dissipating board 72 made of a metal plate having a good thermal conductivity, such as copper, aluminum or the like. The heat dissipating board 72 has a thickness in a range from, e.g., about 3 to 10 mm. An insulating layer 74 is directly formed on the heat dissipating board 72. In other words, the insulating layer 74 is directly formed on the surface of the heat dissipating board 72 without forming the joint layer 4 (see FIGS. 8A and 8B) between the insulating layer 74 and the heat dissipating board 72 by, e.g., soldering used in a conventional heating apparatus.

The insulating layer 74 may be made of a ceramic material such as alumina (Al₂O₃), aluminum nitride (AlN) or silicon carbide (SiC), DLC (Diamond Like Carbon), or a resin having a good thermal conductivity and a high insulation property. Further, the insulating layer 74 may be formed by a thermal spraying film forming method, a CVD (chemical vapor deposition) method, a printing film forming method, or the like.

Specifically, the thermal spraying film forming method is suitable when the insulating layer 74 is made of alumina or aluminum nitride. The CVD film forming method is suitable when the insulating layer 74 is made of silicon carbide or DLC (Diamond Like Carbon). The printing film forming method is suitable when the insulating layer 74 is made of a resin. In any case, the insulating layer 74 is firmly attached to the heat dissipating board 72.

An example of the resin includes a mixture of an aluminum powder and an epoxy resin. The insulating layer 74 preferably has a thickness of, e.g., about 20 to 150 μm. When the thickness of the insulating layer 74 is smaller than 20 μm, a leak current may occur. On the contrary, when the thickness of the insulating layer 74 is larger than 150 μm, the thermal conductivity is decreased, which may lead to deterioration of the cooling efficiency.

A wiring pattern is formed by arranging the rectangular wiring elements 76 in a predetermined pattern on a surface of the insulating layer 74. Here, the adjacent wiring elements 76 are spaced apart from each other with a small gap 78 in order to ensure insulation therebetween. For example, the wiring elements 76 are arranged uniformly in a horizontal and a vertical direction on a horizontal plane (see FIG. 2B). Alternatively, the wiring elements 76 may be arranged randomly instead of being arranged in column-wise and row-wise direction. Each of the wiring elements 76 is made of, e.g., copper, and has a thickness in a range from about 10 to 100 μm. Each of the wiring elements 76 is formed in a rectangular shape of about 0.82 mm×0.55 mm. The smallest one of the gaps 78 between the wiring elements 76 is e.g., about 0.35 mm. Further, the wiring elements 76 is not necessarily made of copper, and may be made of a material selected from a group consisting of copper, tungsten, tantalum, molybdenum and niobium.

The LED elements 70 are respectively mounted on the wiring elements 76. At this time, lower electrodes (not shown) of the LED elements 70 are connected to the wiring elements 76 by soldering or the like. Further, the adjacent LED elements 70 are electrically connected in series by metal wiring lines 82. The metal wiring lines 82 are formed by wire bonding to electrically connect an upper electrode (not shown) of the corresponding LED element 70 to the wiring element 76 adjacent to the corresponding LED element 70. As a result, the LED elements 70 are connected in series, as described above.

FIG. 4 schematically shows an example of a connection state of a group of LED elements. FIG. 4 shows an example in which the LED elements 70 in one LED module 54 are divided into two groups and the LED elements 70 in the same group are connected in series. Further, the LED elements 70 in one LED module 54 may be divided into two or more groups.

The LED elements 70 disposed at a front end and a rear end in each group are respectively connected to electrodes 84A and 84B attached in each LED module 54, so that the power can be supplied to each of the LED elements 70. In that case, the electrodes 84A and 84B are respectively connected to two power supply lines 68. As a result, the LED elements 70 in each group are connected in parallel.

The entire surface of each of the wiring elements 76 and the LED elements 70 as well as the surface of the insulating layer 74 exposed between the adjacent wiring elements 76 are covered by a transparent protective resin 86 against lights (heat rays). Hence, the entire surface of each of the LED modules 54 is sealed. The protective resin 86 may be provided with reflectors or lenses corresponding to the LED elements 70.

Hereinafter, a manufacturing process of the LED modules 54 will be described with reference to FIGS. 5A to 5F. First, a heat dissipating board 72 formed of a metal plate is prepared as shown in FIG. 5A and, then, an insulating layer 74 is directly formed on the surface thereof as shown in FIG. 5B. As described above, the insulating layer 74 can be formed by a thermal spraying film forming method, a CVD film forming method, a printing film forming method, or the like. Here, the insulating layer 74 is formed by thermally spraying a ceramic material such as alumina or the like by a ceramic thermal spraying film forming method.

When the insulating layer 74 is formed by thermally spraying a ceramic material, the surface of the insulating layer 74 is polished and an opening sealing process is performed on the surface thereof, as shown in FIG. 5C. The opening sealing process is performed by impregnating a resin into the surface of the insulating layer 74. Then, as shown in FIG. 5D, a thin metal film 88 for forming a wiring pattern is formed on the surface the insulating layer 74. The metal film 88 can be formed by, e.g., copper plating or copper thermal spraying. Next, as shown in FIG. 5E, the metal film 88 is pattern-etched, thereby forming a wiring pattern formed of a plurality of wiring elements 76 (88).

Thereafter, as shown in FIG. 5F, the LED elements 70 are mounted on the wiring elements 76, and the adjacent LED elements 70 are connected by the metal wiring lines 82 formed by wire bonding. Next, the LED module 54 is completely manufactured by providing the protective resin 86.

Referring back to FIG. 1, the controls of the operations of the annealing apparatus 12, e.g., various controls of a processing temperature, a processing pressure, a gas flow rate and on/off of the top surface-side heating apparatus 42 or the bottom surface-side heating apparatus 44, are performed by a controller 90 formed of a computer. Further, computer-readable programs required for such controls are stored in a storage medium 92. An example of the storage medium 92 includes a flexible disc, a CD (compact disc), a CD-ROM, a hard disc, a flash memory, a DVD and the like.

Hereinafter, an annealing process performed by using the annealing apparatus 12 will be described. First, a semiconductor wafer W, e.g., a silicon substrate, is loaded from a load-lock chamber (not shown), a transfer chamber (not shown) or the like that is previously set in a depressurized atmosphere into the processing chamber 14 previously set in a depressurized atmosphere through the loading/unloading port 16 by a transfer unit (not shown).

Since an amorphous silicon film, a metal film, or an oxide film is formed on the surface of the wafer W, the wafer W has a surface state in which various fine regions having different absorption rates depending on wavelengths of heat rays are formed. The loaded wafer W is mounted on the supporting pins 22 installed at the elevation arm 24 by vertically moving the elevation arm 24. After the transfer unit is retreated, the gate valve 18 is closed and the processing chamber 14 is sealed.

Then, a processing gas, e.g., N₂ gas, Ar gas or the like, is supplied at a controlled flow rate through the gas line 30 of the gas supply unit 26, and the pressure inside the processing chamber 14 is maintained at a predetermined level. At the same time, the top surface-side heating apparatus 42 installed at the ceiling plate 14B and the bottom surface-side heating apparatus 44 installed at the bottom plate 14C are powered, and the LED elements 70 of the top surface-side heating apparatus 42 and those of the bottom surface-side heating apparatus 44 are switched on to emit heat rays. As a consequence, the wafer W is heated from both sides and annealed. In this case, a processing pressure ranges from, e.g. about 100 to 10000 Pa; a processing temperature (wafer temperature) ranges from, e.g., about 800 to 1100° C.; and a lighting time of each of the LED elements 70 ranges from about 1 to 10 seconds.

Since the heat rays having specific widths of emission wavelength are irradiated from the respective LED elements 70 to the top surface and the bottom surface of the wafer W, the top surface and the bottom surface of the wafer W can be heated to a substantially uniform temperature without depending on the surface state of the wafer W. Although the element attachment heads 46 are heated by a large amount of heat produced from the heating apparatuses 42 and 44, it is possible to efficiently cool the element attachment heads 46 by allowing the coolant to flow in the coolant paths 60 of the cooling units 58.

Specifically, in each of the heating apparatuses 42 and 44, the power is supplied to the LED modules 54 through the supply lines 68 from the control boards 66. Further, the LED elements 70 of the LED module 54 which are connected in series are driven to irradiate heat rays as indicated by arrows 94 in FIG. 3A.

As a result, the wafer W is quickly heated from the top surface and the bottom surface thereof. At this time, a large amount of heat is generated from each of the LED elements 70. In the conventional heating apparatus, the heat dissipating board 72 and the insulating plate 6 made of a ceramic material or resin are coupled to each other by the joint layer 4 such as solder. However, the cooling is insufficient due to the low thermal conductivity of the joint portion. Thus, peeling off is caused by a linear expansion difference, or air bubbles are generated in the joint layer 4, which results in non-uniform heat dissipation (see FIGS. 8A and 8B).

However, in the present embodiment, the insulating layer 74 is directly formed on the heat dissipating board 72 without the joint layer 4 (see FIGS. 8A and 8B) by using, e.g., a thermal spraying method, a CVD method, or a printing method as described above. The insulating layer 74 thus generated has a considerably thin thickness in a range from about 20 to 150 μm. As a result, the LED elements 70 can be efficiently cooled and thus prevented from being excessively heated. Further, by using the above-described manufacturing method, it is possible to obtain the advantage in which bonding strength between the heat dissipating board 72 and the insulating layer 74 can be increased, in addition to the advantage in that the overheating of the LED element 70 can be prevented. Hence, the occurrence of peeling off can be suppressed.

Besides, in the present embodiment, the joint layer 4 (see FIGS. 8A and 8B) such as solder or the like, which may have air bubbles therein, is unnecessary, so that the entire part of the insulating layer 74 can be uniformly cooled without non-uniform heat distribution. Furthermore, the LED elements 70 of which heat radiation efficiency tends to be decreased at a high temperature can be sufficiently cooled as described above, so that the heat radiation efficiency of the LED elements 70 can be increased.

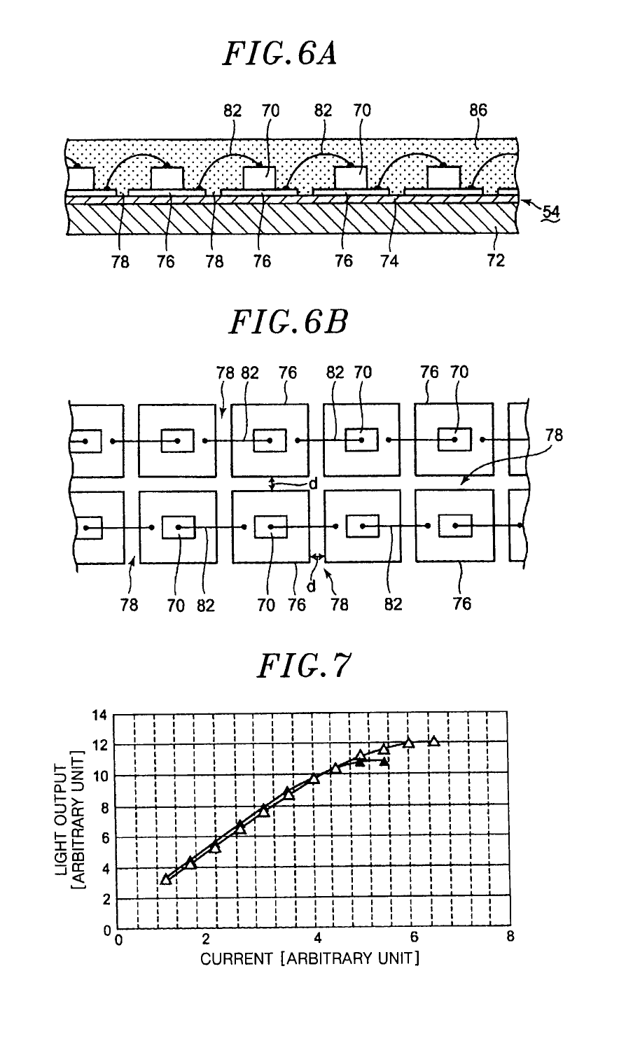

Next, a second embodiment of the present invention will be described. As described above, in the heating apparatus including LED elements, it is critical to efficiently cool the LED elements in order to increase the heat radiation efficiency of the LED elements. However, in the second embodiment, an area of the wiring elements 76 that contribute to heat dissipation is set as large as possible. FIGS. 6A and 6B are partially enlarged views showing the LED elements of the second embodiment, wherein FIG. 6A is a cross section view and FIG. 6B is a plan view. Further, in FIGS. 6A and 6B, like reference numerals will be used for like parts as those of FIG. 3, and the description thereof will be omitted.

As shown in FIGS. 6A and 6B, the area of the wiring elements 76 made of a metal and formed on the insulating layer 74 is set as large as possible, so that heat is efficiently transmitted from the wiring elements 76 to the heat dissipating board 72 through the insulating layer 74, thereby realizing more efficient heat dissipation. Since the wiring elements 76 have a function of dissipating heat as described above, the more efficient heat dissipation can be achieved as the wiring elements have larger area. In that case, a width “d” of the gap 78 between the adjacent wiring elements 76 in column-wise and row-wise directions on a horizontal plane where the LED elements 70 are arranged is set to such a level as to generate no discharge between the adjacent wiring elements 76 based on Paschen's law.

Specifically, the width d of the gap 78 between the adjacent wiring elements 76 is set in such a way that “Vm/a<d” is satisfied, wherein “a” indicates an dielectric breakdown electric field of an insulating member provided between the wiring elements 76 and “Vm” indicates a maximum potential difference between the wiring elements 76. In other words, the width “d” of the gap 78 between the adjacent wiring elements 76 is set to be larger than “Vm/a” in order to prevent discharge from being generated between the adjacent wiring elements 76. Besides, “the insulating member provided between the wiring elements 76” indicates the protective resin 86 that seals the LED elements 70.

As for the protective resin 86, a silicon resin for lens is generally used, for example. The dielectric breakdown electric field varies from about 20 to 30 kV/mm depending on the type of material. When the dielectric breakdown electric field is set to about 10 kV/mm in view of safety, the minimum value of the width d becomes “Vm/10k”. Generally, a voltage in a range from about 1 to 5 V is applied to one LED element 70, and a maximum voltage between adjacent LED elements 70 is, e.g., about 100 V, although it depends on an applied voltage or an arrangement pattern of LED elements. Therefore, the minimum value of the width d is 10⁻² mm, and the width needs to be set to be larger than or equal to about 10⁻² mm. Further, the width d may vary depending on arrangement positions of the LED elements 70 in one LED module. The maximum value of the width d corresponds to a distance between the adjacent LED elements 70.

In the second embodiment shown in FIGS. 6A and 6B, the insulating layer 74 is directly formed on the heat dissipating board 72. However, the setting of the width d of the gap 78 may be applied to the configuration in which the insulating plate 6 is formed on the top surface of the heat dissipating board 72 via the joint layer 4 as shown in FIGS. 8A and 8B. Even in that case, the heat dissipation efficiency of the LED elements 70 can be increased, and this leads to improvement of the heat radiation efficiency.

Here, an operation test was performed to compare the conventional configuration shown in FIGS. 8A and 8B as a comparative example with a test example in which the area of the wiring elements 76 is increased by applying the above setting of the width d of the gap 78 to the heating apparatus of FIGS. 8A and 8B in which the insulating plate 6 is formed on the top surface of the heat dissipating board 72 via the joint layer 4. Hereinafter, the result thereof will be explained. FIG. 7 is a graph showing a test result. The horizontal axis indicates a current (arbitrary unit) flowing in the LED elements, and the vertical axis indicates a light output (arbitrary unit) of the LED elements.

In the heating apparatuses used for the test, 72 LED elements are installed per cm². The wiring elements of the comparative example have a rectangular shape of about 0.82 mm×0.55 mm, and the width d of the gap between the adjacent wiring elements is set to about 0.35 mm. The wiring elements of the test example have a rectangular shape of about 0.83 mm×0.75 mm, and the width d of the gap is set to about 0.15 mm. As can be seen from FIG. 7, when the current is gradually increased, the same curve is shown both in the test example (indicated by Δ) and the comparative example (indicated by ▴) and the light output is increased. In the comparative example, the light output is quickly saturated. On the other hand, the light output of the heating apparatus in the text example is relatively slowly saturated, so that an increased cooling efficiency can be achieved. The amount of current until the light output is saturated is larger in the text example than in the comparative example. As a consequence, the input current can be increased.

In the above-described embodiments, a target object to be processed is a semiconductor wafer. The semiconductor wafer includes a silicon substrate or a compound semiconductor substrate such as GaAs, SiC and GaN. Further, the target object is not limited to such substrates, and may also be a ceramic substrate or a glass substrate used in a liquid crystal display apparatus.

While the invention has been shown and described with respect to the embodiments, it will be understood by those skilled in the art that various changes and modifications may be made without departing from the scope of the invention as defined in the following claims.

What is claimed is:

1. A heating apparatus comprising:
a heat dissipating board formed of a metal;
an insulating layer directly formed on the heat dissipating board;
a plurality of wiring elements which are arranged on the insulating layer in a wiring pattern;
a plurality of LED elements provided on the wiring elements, respectively; and
metal wiring lines which electrically connect the adjacent LED elements to each other in series.

2. The heating apparatus of claim 1, wherein the insulating layer is formed by any one of a thermally spraying film forming method, a CVD (Chemical Vapor Deposition) film forming method and a printing film forming method.

3. The heating apparatus of claim 1, wherein the insulating layer is made of a material containing a ceramic material.

4. The heating apparatus of claim 1, wherein the insulating layer has a thickness in a range from about 20 to 150 μm.

5. The heating apparatus of claim 1, wherein a width “d” of a gap between the adjacent wiring elements is set to such a level as to satisfy a relational expression Vm/a<d, where “a” indicates a dielectric breakdown electric field of an insulating member provided between the wiring elements and “Vm” indicates a maximum potential difference between the wiring elements.

6. A heating apparatus comprising:
a heat dissipating board formed of a metal;
an insulating layer formed on the heat dissipating substrate;
a plurality of wiring elements which are arranged on the insulating layer in a wiring pattern;
a plurality of LED elements provided on the wiring elements, respectively; and
metal wiring lines which electrically connect the adjacent LED elements to each other in series,
wherein a width “d” of a gap between the adjacent wiring elements is set to such a level as to satisfy a relational expression Vm/a<d, where indicates a dielectric breakdown electric field of an insulating member provided between the wiring elements and “Vm” indicates a maximum potential difference between the wiring elements.

7. The heating apparatus of claim 6, wherein the insulating layer is directly formed on the heat dissipating board.

8. The heating apparatus of claim 6, wherein the insulating layer is formed on the heat dissipating board via a joint layer.

9. The heating apparatus of claim 1, wherein the insulating member provided between the wiring elements serves to seal the LED elements.

10. The heating apparatus of claim 6, wherein the insulating member provided between the wiring elements serves to seal the LED elements.

11. The heating apparatus of claim 1, further comprising:
an element attachment head provided with a cooling unit,
wherein one or more LED modules are provided at the element attachment head.

12. The heating apparatus of claim 6, further comprising:
an element attachment head provided with a cooling unit,
wherein one or more LED modules are provided at the element attachment head.

13. The heating apparatus of claim 1, wherein the wiring element is made of a material selected from the group consisting of copper, tungsten, tantalum, molybdenum and niobium.

14. The heating apparatus of claim 6, wherein the wiring element is made of a material selected from the group consisting of copper, tungsten, tantalum, molybdenum and niobium.

15. An annealing apparatus for annealing a target object to be processed, the apparatus comprising:
a processing chamber for accommodating the target object;
a supporting unit for supporting the target object in the processing chamber;
a gas supply unit for supplying a processing gas into the processing chamber;
a gas exhaust unit for exhausting an atmosphere in the processing chamber; and
the heating apparatus, provided in the processing chamber, described in claim 1.

16. The annealing apparatus of claim 15, wherein the number of the heating apparatuses is two, and the heating apparatuses are respectively provided to face a top surface and a bottom surface of the target object accommodated in the processing chamber.
